(19) United States
(12) Patent Application Publication
(10) Pub. No.: US 2016/0176327 A1
(43) Pub. Date: Jun. 23, 2016

(54) BACKREST FOR A VEHICLE SEAT, AND VEHICLE SEAT

(71) Applicant: JOHNSON CONTROLS GMBH, Burscheid (DE)

(72) Inventors: Sascha TIPPL, Leutenbach (DE); Frank BEERMANN, Kirchheim/Teck (DE); Tobias SIEGL, Deggingen (DE); Tobias KUTSCHAL, Reutlingen (DE)

(21) Appl. No.: 14/909,827

(22) PCT Filed: Aug. 29, 2014
(86) PCT No.: PCT/EP2014/068451

§ 371 Date: Feb. 3, 2016

(30) Foreign Application Priority Data
Aug. 30, 2013 (DE) 10 2013 217 338.5
Dec. 10, 2013 (DE) 10 2013 225 477.6

(51) Int. Cl. B60N 2/68; B60N 2/20; B60N 2/48

(52) U.S. Cl. CPC B60N 2/68; B60N 2/4885; B60N 2/20

(57) ABSTRACT

A backrest (100) for a vehicle seat (1) includes a monocoque supporting backrest structure (110), wherein at least the rear side of the backrest structure (110) is covered by a design shell (130). The backrest structure (110) is provided with an opening (113) which is laterally delimited by two lateral parts (111) of the backrest structure (110). The width of the opening is at least 50% of the maximum width of the backrest structure (110). A vehicle seat (1), more particularly a sports vehicle seat, includes such a backrest (100).

### CROSS REFERENCE TO RELATED APPLICATIONS

This application is a United States National Phase Application of International Application PCT/EP2014/068451 filed Aug. 29, 2014, and claims the benefit of priority under 35 U.S.C. §119 of German Patent Applications DE 10 2013 217 338.5 filed Aug. 30, 2013, and DE 10 2013 225 477.6 filed Dec. 10, 2013, the entire contents of which are incorporated herein by reference.

### FIELD OF THE INVENTION

The invention relates to a backrest for a vehicle seat, having a load-bearing backrest structure of shell type of construction and having a design shell which covers at least the rear side of the backrest structure, and to a vehicle seat having the backrest structure.

### BACKGROUND OF THE INVENTION

DE 10 2005 059 854 B4 has disclosed a backrest for a vehicle seat, the load-bearing structure of which backrest is of a shell type of construction composed of a fiber-reinforced plastics shell, which has a reduced material thickness and/or recesses in those regions which are subjected to low load with regard to the absorption of force. The plastics shell comprises, on the rear side averted from the occupant, an externally visible cover as an outermost layer, and thus defines the external appearance of the backrest.

U.S. Pat. No. 3,713,696 has disclosed a backrest for a vehicle seat, which backrest has a load-bearing backrest structure of shell type of construction and a design shell which covers the rear side of the backrest structure. On the front side, the backrest structure bears multiple cushioning pads and is in the form of a closed shell. In one embodiment, the shell has a narrow, vertically running slot which permits a resilience of the cushioning pads.

### SUMMARY OF THE INVENTION

The invention is based on the problem of providing a backrest for a vehicle seat having a load-bearing backrest structure of shell type (shell) construction. The external appearance of the backrest can be varied within a broad scope without the need for adaptation of the backrest structure. A corresponding vehicle seat having a backrest of said type is provided. The vehicle seat is furthermore optimized in terms of weight.

This problem is solved according to the invention by way of a backrest for a vehicle seat, having a load-bearing backrest structure of shell type of construction and having a design shell which covers at least the rear side of the backrest structure, wherein an opening is provided in the backrest structure, the opening is delimited by two side parts of the backrest structure, and the width of the opening amounts to at least 50% of the maximum width of the backrest structure. In the description of the figures, the opening is referred to as first opening in order to distinguish it from further openings that may be provided in the backrest structure.

The maximum width of the opening preferably amounts to at least 50% of the maximum width of the backrest structure. The maximum width of the opening most preferably amounts to at least 75% of the maximum width of the backrest structure. In the vertical direction z, the greatest height of the opening preferably amounts to at least 15%, most preferably at least 20%, of the maximum height of the backrest structure.

By virtue of the fact that an opening is provided in the backrest structure, the opening is delimited by two side parts of the backrest structure, and the width of the opening amounts to at least 50% of the maximum width of the backrest structure, the backrest structure can be of particularly lightweight form. The side parts offer adequate protection against loading.

By virtue of the fact that at least the rear side of the load-bearing backrest structure is covered by a design shell, it is furthermore possible for the backrest structure, which is of shell type of construction and equipped with an opening, to be constructed in an optimized manner in terms of weight and comfort, without consideration being given to the external appearance of the vehicle seat. The external appearance of the vehicle seat is defined by the design shell. The shaping of the load-bearing backrest structure is thus substantially independent of the external appearance of the backrest, which is to be realized. The backrest structure may furthermore be used as an identical part in different backrests of different design. A change in design of the vehicle seat at short notice is possible by modifying the design shell, without the need to modify the safety-relevant, load-bearing backrest structure. Furthermore, the appearance of the design shell may be varied by way of paint, printing or the use of colored films, without the risk of the crash characteristics of the vehicle seat being influenced, for example by chemical reactions between load-bearing structures and paint.

The opening is preferably delimited in a downward direction by a crossmember of the backrest structure, which cross member may be formed integrally with the backrest structure or is a separate component.

In a particularly weight-optimized embodiment, it is provided that, proceeding from two outer and lower corner regions of the backrest structure, the side parts run so as to be curved toward the seat center with increasing height in an upward direction. The two side parts preferably merge into one another and thereby delimit the opening in the upward direction.

The expression “load-bearing backrest structure” is to be understood in this case to mean a backrest structure which, owing to its strength and stiffness, can accommodate a major part of the forces acting on the backrest under the action of load, for example during a crash. A shell type of construction (shell construction) is to be understood to mean an areal and curved type of construction with locally only little profiling, which may however by all means also have openings in individual regions. By contrast to such a shell type of construction, backrest frames of frame type of construction (frame construction), for example backrest frames welded from individual sheet-steel profiles, have a highly profiled frame structure.

The design shell covers at least the rear side of the backrest structure, that is to say the side averted from the back of an occupant, though may also conceal lateral subregions, for example in the region of seat side bolsters that support the body of the occupant during cornering maneuvers.

The front side of the backrest structure is preferably covered entirely by a cushion. The cushion and design shell then fully encase the backrest structure.

For weight minimization, the backrest structure is of lightweight type of construction, formed in particular from a lightweight structural material. Metallic lightweight structural materials are for example aluminum, magnesium, high-strength steels and titanium. Furthermore, fiber composite materials are also classic lightweight structural materials.

The backrest structure may be in the form of a carbon shell, in particular in the form of a unipartite carbon shell, in a particularly optimized manner in terms of weight. The weight advantages of the carbon hybrid material can be optimally utilized because the backrest structure can be designed substantially without consideration being given to the external appearance of the vehicle seat.

The backrest structure is preferably ergonomically shaped and thereby physiologically adapted to the occupant. In this way, a high level of seating comfort is achieved even with the use of thin cushion layers. The occupant becomes tired less quickly, and the risk of injury, in particular in the event of a rear-end crash, is reduced.

A contour of the backrest structure adapted to an SAE H-point manikin (also referred to as SAE J826 H-point manikin) makes it possible to realize a backrest which is particularly optimized with regard to structural space and comfort. The foam padding between an occupant of the vehicle seat and the backrest structure can be minimized. The structural space for an occupant in a seat row arranged behind the vehicle seat can thereby be increased. The ergonomic shaping furthermore makes it possible to realize a backrest structure without sharp edges, and is thereby suitable for the use of carbon.

In the region of the side parts of the backrest structure, the spacing between the SAE H-point manikin and the backrest structure should amount to 20 mm to 40 mm. In this way, good comfort is ensured, with a small structural space requirement. The spacing between the SAE H-point manikin and the backrest structure preferably amounts to 20 mm to 30 mm.

The combination of a backrest structure with a design shell permits a high level of integration of functions into the backrest structure without adversely affecting the design, and thus permits a reduction in the number of components. The complexity and the assembly time of the vehicle seat are also reduced in this way.

In the vertical direction, the backrest structure is, in the region of the shoulders of a seat occupant, constricted to form a web. In this way, the backrest structure can also be used in conjunction with belt leadthroughs through the backrest, such as is conventional in the case of sports seats and such as is known for example from DE 10 2006 005 506 A1. The width of the web in the transverse direction amounts to less than half, preferably less than one third, and most preferably less than one quarter, of the maximum width of the backrest structure.

The design shell may be of open design, that is to say with openings and slots for improving the seat microclimate, for example for passive air ventilation or air circulation.

An integration of a side airbag is possible on the outer side and/or on the inner side of the design shell.

The backrest structure preferably comprises, in its upper region, a headrest support for receiving a headrest module. The headrest support is an interface to different headrest modules, which can be removed and installed, for example from a modular set, in accordance with customer demand.

The passive safety of the vehicle seat can be increased through integration of a headrest which is active in the event of a crash, such as is known for example from DE 102 15 054 A 1.

A further weight reduction can be achieved through the use of a so-called lightweight foam as a foam part.

An optimized attachment of the backrest structure to the fitting upper part of a fitting for backrest inclination adjustment provides that the fitting upper part can be received in positively locking fashion in a depression of the backrest structure. The fitting upper part is advantageously additionally adhesively bonded to the backrest structure 110 in the region of the depression.

The backrest according to the invention may be used particularly advantageously for sports seats, though is not restricted to use in sports seats.

The problem is furthermore solved by way of a vehicle seat having a backrest according to the invention.

The invention will be discussed in more detail below on the basis of an advantageous exemplary embodiment illustrated in the figures. The invention is however not restricted to said exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a vehicle seat;

FIG. 2 is an exploded illustration of the exemplary embodiment;

FIG. 3 is a perspective view of the front side of a backrest structure of the backrest of the exemplary embodiment;

FIG. 4 is a front view of the backrest structure from FIG. 3;

FIG. 5 is a side view of the backrest structure from FIG. 3;

FIG. 6 is a rear view of the backrest structure from FIG. 3;

FIG. 7 is a perspective view of an SAE H-point manikin positioned in the structure of the vehicle seat, with the design shell not illustrated;

FIG. 8 is a further perspective view, similar to FIG. 7, of an SAE H-point manikin positioned in the structure of the vehicle seat;

FIG. 9 is a detail view from the side view from FIG. 5;

FIG. 10 is a section along the line X-X in FIG. 9;

FIG. 11 is a detail view from a plan view of the backrest structure from FIG. 3; and

FIG. 12 is a section along the line XII-XII in FIG. 11.

### DESCRIPTION OF THE PREFERRED EMBODIMENTS

A vehicle seat 1, which in the present case is in the form of a sports seat, for a motor vehicle has a backrest 100 and a seat base 200. The backrest 100 and the seat base 200 are connected to one another by way of two fittings 10 such as are known per se. For this purpose, each of the two fittings 10 has a fitting upper part 20, which is connected to a backrest structure 110 of the backrest 100, and a fitting lower part 30, which is connected to a seat base structure 210 of the seat base 200. The fitting upper part 20 and the fitting lower part 30 are adjustable relative to one another by way of a fitting mechanism such as is known per se, such that the inclination of the backrest 100 can be adjusted about a backrest pivot axis A. A corresponding geared fitting is known for example from DE 10 2010 035 377 A1.

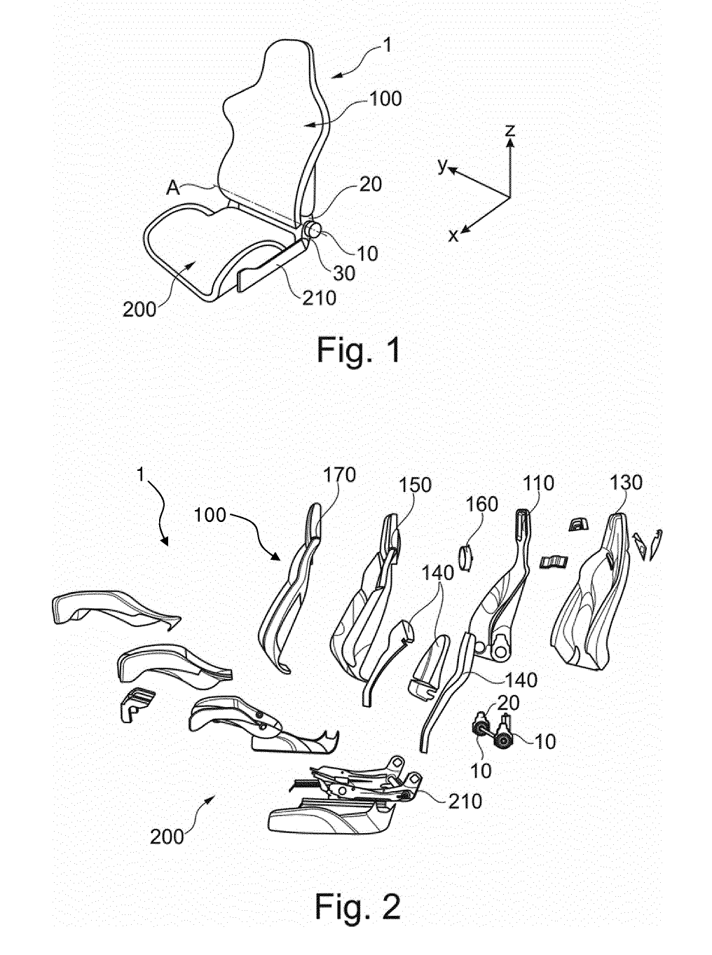

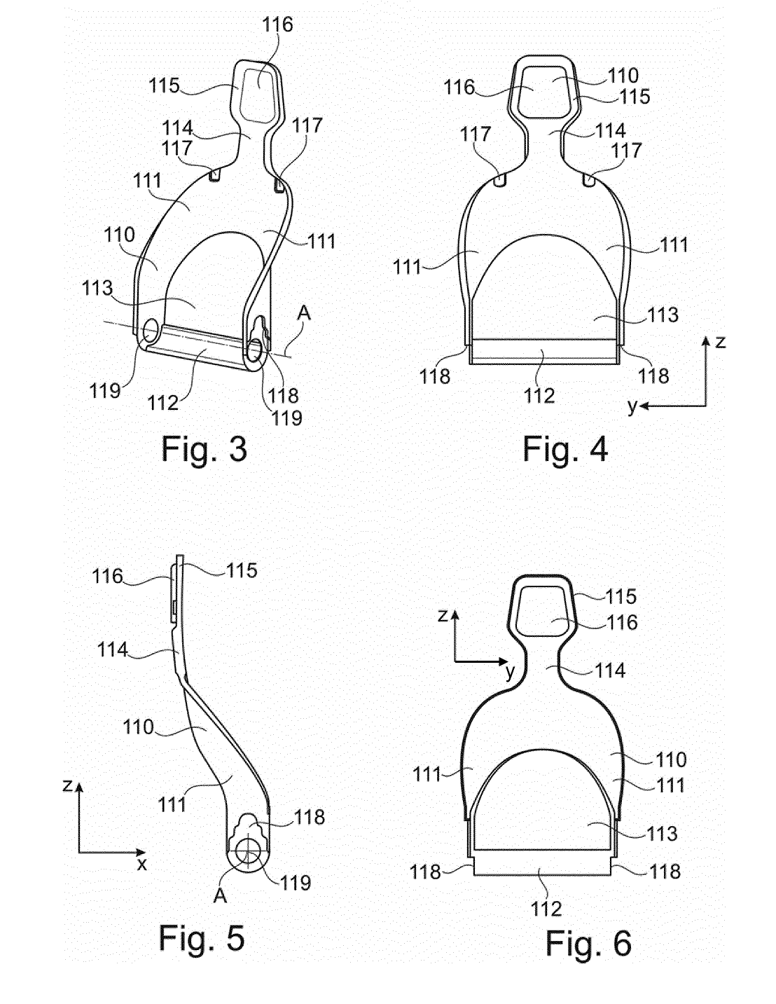

The vehicle seat 1 schematically illustrated in FIG. 1 will be described below using three mutually perpendicular spatial directions. In the case of a vehicle seat 1 installed in the vehicle, a longitudinal direction x runs substantially horizontally and preferably parallel to a vehicle longitudinal direction, which corresponds to the normal direction of travel of the vehicle. A transverse direction y, which runs perpendicular to the longitudinal direction x, is likewise oriented horizontally in the vehicle, and runs parallel to a vehicle transverse direction. A vertical direction z runs perpendicular to the longitudinal direction x and perpendicular to the transverse direction y. In the case of a vehicle seat 1 installed in the vehicle, the vertical direction z runs parallel to the vehicle vertical axis.

The position and direction statements used, such as for example front, rear, top and bottom, relate to a viewing direction of an occupant seated in the vehicle seat 1 in a normal seating position, wherein the vehicle seat 1 is installed in the vehicle, in a usage position suitable for passenger transport, with an upright backrest 100 and so as to be oriented, in the conventional manner, in the direction of travel. The vehicle seat 1 according to the invention may however also be installed in a different orientation, for example transversely with respect to the direction of travel.

The backrest 100 comprises the backrest structure 110, the rear side of which is concealed by a design shell 130. Multiple inlay parts 140 are arranged on the front side of the backrest structure 110. The front side of the backrest structure 110 and the inlay parts 140 are at least substantially concealed by a foam part 150. The foam part 150 is covered by a lining 170, the outer contours of which are fastened to the design shell 130, such that the lining 170 and the design shell 130, between them, receive the backrest structure 110, the inlay parts 140 and the foam part 150. It is optionally additionally possible for a headrest module 160, in particular for an active adjustment of the headrest position in the event of a crash, to be fastened to the backrest structure 110.

The backrest structure 110 is a load-bearing structural part of the vehicle seat 1. The forces, in particular crash forces, acting on the backrest 100 are substantially accommodated by the backrest structure 110 and transmitted via the fittings 10 into the seat substructure 210.

The backrest structure 110 is in the present case manufactured from carbon fiber-reinforced plastic as a so-called carbon shell. Alternatively, however, the structure may also be composed of a high-strength plastic, some other fiber composite material, or sheet metal, or may be formed as a metal injection molded part. In the present case, the backrest structure 110 is of unipartite form, though may alternatively also be assembled from multiple individual parts.

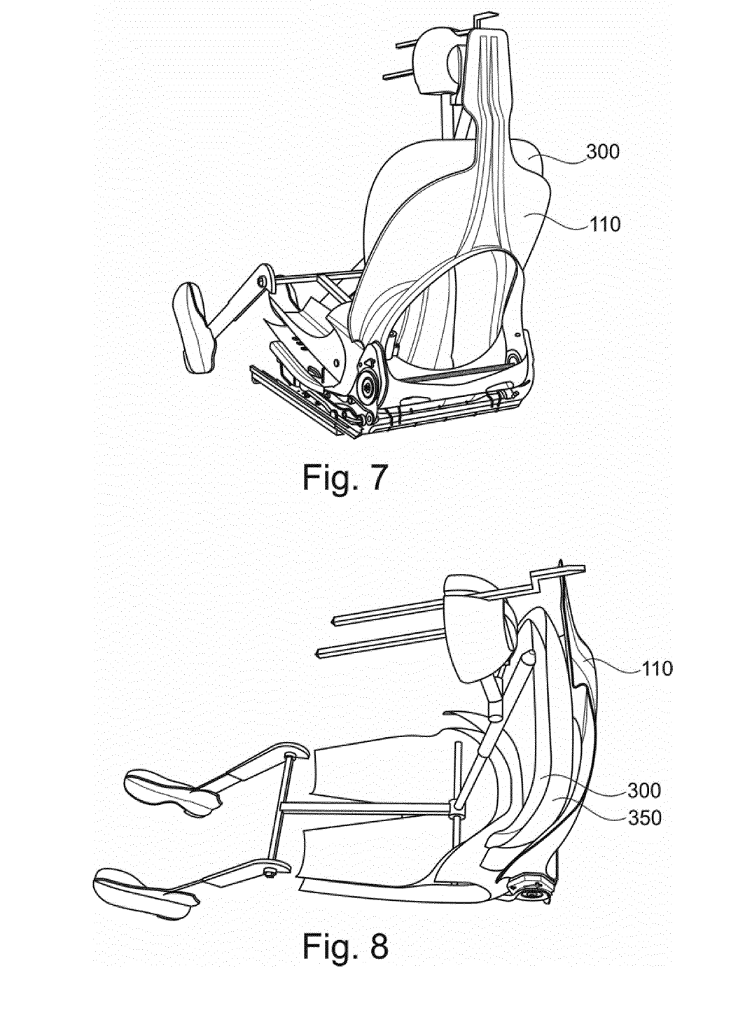

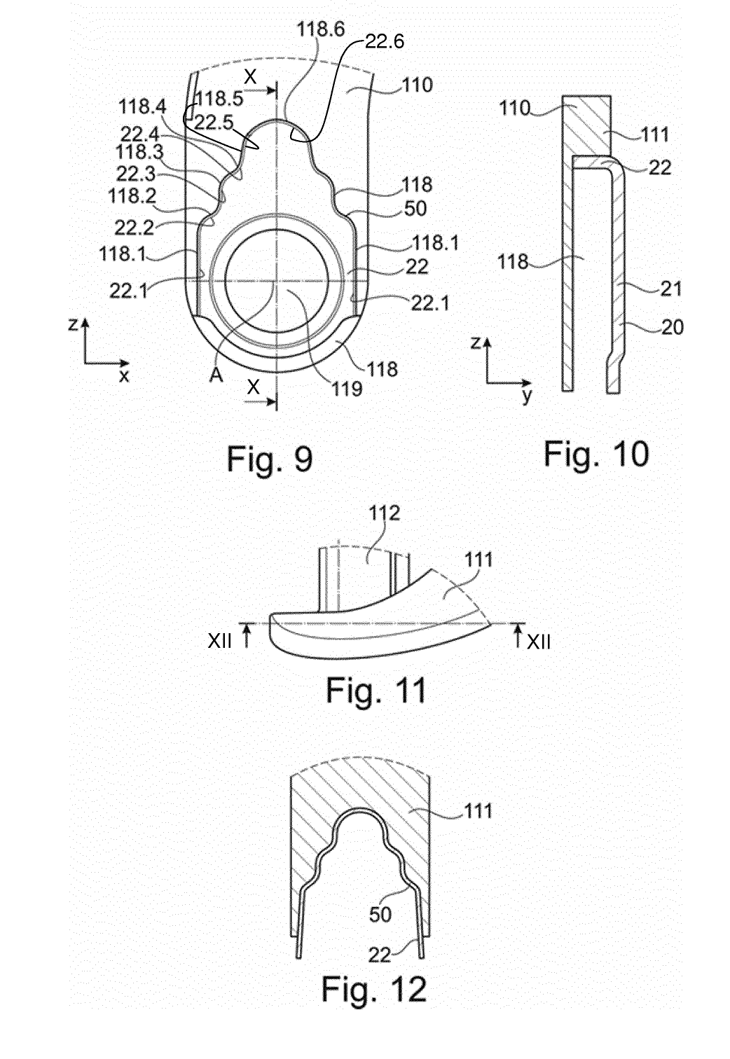

As illustrated in FIGS. 7 and 8, the backrest structure 110 is ergonomically shaped such that the spacing between the backrest structure 110 and an SAE H-point manikin 300 (conforming to SAE standard J826) positioned correctly in the vehicle seat 1, in particular the bowl-like buttocks and back parts of said manikin, is at least approximately equidistant. In the back region in particular, that surface of the backrest structure 110 which is oriented toward the occupant substantially corresponds to an equidistant surface 350 which runs so as to be spaced apart by 30 mm from the back part of the SAE H-point manikin 300. The structural space resulting from said spacing is, in the case of a fully cushioned vehicle seat 1, filled by the inlay parts 140, the foam part 150 and the lining 170.

The design shell 130 and the lining 170 define the exterior design of the backrest 100 without contributing significantly to the strength of the backrest 100. The design shell 130 is in the present case in the form of an injection-molded part composed of a plastic known per se. The lining 170 is preferably composed substantially of fabric and/or leather.

The inlay parts 140 are produced preferably from expanded polypropylene (EPP) and serve for the fastening of further components (not illustrated in the Figures) within the backrest 100. Further components are for example lumbar supports, electric drives or side bolster adjustment mechanisms, such as are known per se. The inlay parts 140 contribute only insignificantly to the strength of the backrest 100.

In the present case, the foam part 150 is composed of a polyurethane soft foam and serves substantially for seating comfort, without contributing significantly to the strength of the backrest 100.

The backrest structure 110 is substantially mirror-symmetrical with respect to a plane which runs, parallel to the longitudinal direction x and parallel to the vertical direction z, through the seat center.

The backrest structure 110 comprises, in the two outer regions as viewed in the transverse direction y, a side part 111 of substantially areal form. Proceeding in the vertical direction z from a lower region which is arranged around the backrest pivot axis A and which is oriented perpendicular to the backrest pivot axis A, the two side parts 111 run in each case upward so as to be increasingly curved and turned toward the seat center, and merge into one another there. In the lower region of the backrest structure 110, the two side parts 111 are connected to one another by way of a crossmember 112 running in the transverse direction y. The crossmember 112 between the two side parts 111 the lower delimitation of the backrest structure 110.

The two side parts 111 and the crossmember 112 form, between them, a first opening 113. Owing to the opening 113, the backrest structure 110 is an open shell. The first opening 113 is approximately in the shape of a semiellipse. The maximum width of the first opening amounts to at least 50% of the maximum width of the backrest structure 110. The first opening 113 extends in the vertical direction z over at least up to 15% of the total height of the backrest structure 110. The first opening 113 is mirror-symmetrical with respect to a plane which runs, parallel to the longitudinal direction x and parallel to the vertical direction z, through the seat center. The first opening 113 is arranged in a region of the backrest structure 110 which is not burdened by payload in the event of a crash. In the event of a crash, payload is restrained by the two side parts 111 which merge into one another. In relation to a backrest shell without an opening, the backrest structure 110 has material only in those regions which are subjected to high loads in the event of a crash.

Proceeding from the region of the backrest structure in which the two side parts 111 merge into one another, a web 114 runs upward in the region of the seat center and ends in a trapezoidal headrest support 115. The headrest support 115 has a headrest receptacle 116 in the form of a depression.

In each case one fastening point 117 in the upper region of each side part 111 serves for the fastening of the design shell 130, which is hooked onto the backrest structure 110 there from above, for example by way of in each case one integrally molded tongue-like lug.

Each of the two side parts 111 has, in its lower region, a depression 118 in the transverse direction y for receiving the fitting upper part 20 in positively locking fashion.

Like the rest of the side part 111 in its lower region, the depression 118 runs substantially areally and perpendicular to the backrest pivot axis A. In the middle of the depression 118 there is situated a circular second opening 119, the central point of which lies on the backrest pivot axis A.

In the present case, the depression 118 is mirror-symmetrical with respect to a plane of symmetry which encompasses the backrest pivot axis A and which runs approximately in the vertical direction z. The spacing between the border of one half of the depression 118 and the plane of symmetry varies in the vertical direction z, and defines the width of the depression 118.

The depth of the depression 118 in relation to the adjacent region of the side part 111 is constant. The width of the depression 118 decreases in stepped fashion from bottom to top in the vertical direction z, wherein the steps are of rounded form. The outer delimitation of the depression 118 with respect to the adjacent region of the side part 111 is formed by an edge region. The depression 118 is not bordered in the downward direction.

At the height of the backrest pivot axis A, the width of the depression 118, between two first edge regions 118.1 which run linearly and approximately parallel to one another, is at its greatest. Each first edge region 118.1 is adjoined in the upward direction by in each case one second edge region 118.2. The two second edge regions 118.2 form in each case one rounded step between the two first edge regions 118.1 and two third edge regions 118.3, which run linearly and approximately parallel to one another. Each third edge region 118.3 is adjoined in the upward direction by in each case one fourth edge region 118.4. The two fourth edge regions 118.4 form in each case one rounded step between the two third edge regions 118.3 and two fifth edge regions 118.5 which run linearly and approximately parallel to one another. At the two upper ends of the two fifth edge regions 118.5, the two fifth edge regions 118.5 are connected to one another by a semicircular curved sixth edge region 118.6.

The two fifth edge regions 118.5 are of shorter form than the two first and third edge regions 118.1, 118.3 and, in a modification of the exemplary embodiment, are omitted entirely, such that the two fourth edge regions 118.4 in this case merge directly into the sixth edge region 118.6.

The edge regions 118.1, 118.3 and 118.5, which run in each case approximately parallel to one another, preferably converge on one another slightly in the upward direction, in a slight deviation from parallelism, such that in the approximately parallel regions, the depression 118 also tapers conically slightly in the upward direction. The expression “approximately parallel” is therefore intended to encompass both mathematically exact parallelism and angular deviations of up to 5°.

The depth of the edge regions 118.1 to 118.6 in the transverse direction y defines the depth of the depression 118.

In the present case, the second fitting upper part 20 is manufactured from sheet steel and has a main body 21 which runs substantially parallel to the longitudinal direction x and to the vertical direction z. The outer contour of the main body 21 has a flange 22 which is oriented perpendicular to the main body 21 in the transverse direction y and in the direction of the seat center. The flange 22 is divided into multiple regions which are in each case of complementary form with respect to the edge regions 118.1 to 118.6 of the depression 118, such that the depression 118 receives the flange 22 within it in positively locking fashion. In the present case, in each case two first flange regions 22.1 bear against the two first edge regions 118.1, two second flange regions 22.2 bear against the two second edge regions 118.2, two third flange regions 22.3 bear against the two third edge regions 118.3, two fourth flange regions 22.4 bear against the two fourth edge regions 118.4, two fifth flange regions 22.5 bear against the two fifth edge regions 118.5, and a sixth flange region 22.6 bears against the sixth edge region 118.6, possibly with the interposition of an adhesive 50.

In a modification of the exemplary embodiment, for the compensation of manufacturing tolerances, only some of the flange regions 22.1 to 22.6 bear against the associated edge regions 118.1 to 118.6. In some cases, the flange regions 22.1 to 22.6 are spaced apart slightly from the associated edge regions 118.1 to 118.6.

In the present case, the flange 22 and thus the fitting upper part 20 are additionally adhesively bonded to the backrest structure 110. For this purpose, a thin layer of the adhesive 50 is provided between the flange regions 22.1 to 22.6 and the edge regions 118.1 to 118.6 which bear against one another.

In a further exemplary embodiment which is not illustrated in the Figures, the crossmember is formed as a separate component and is joined, together with the fittings, to the backrest structure. The first opening is thus delimited in a downward direction not by a part of the backrest structure but by a separately formed component.

The features disclosed in the above description, in the claims and in the drawings may be of importance both individually and in combination for the realization of the invention in its various refinements.

While specific embodiments of the invention have been shown and described in detail to illustrate the application of the principles of the invention, it will be understood that the invention may be embodied otherwise without departing from such principles.

1. A backrest for a vehicle seat, the backrest comprising:
a load-bearing backrest structure of a shell constructions; and
a design shell which covers at least a rear side of the backrest structure, wherein an opening is provided in the backrest structure, the opening is delimited by two side parts of the backrest structure, and the width of the opening amounts to at least 50% of a maximum width of the backrest structure.

2. The backrest as claimed in claim 1, wherein the opening is delimited in a downward direction by a crossmember of the backrest structure.

3. The backrest as claimed in claim 1, wherein proceeding from two outer and lower corner regions of the backrest structure, in each case one of the two side parts runs upward and is increasingly curved toward the seat center.

4. The backrest as claimed in claim 1, wherein the two seat parts merge into one another and delimit the opening in an upward direction.

5. The backrest as claimed in claim 1, wherein the backrest structure is of a lightweight construction, formed from a lightweight structural material.

6. The backrest as claimed in claim 5, wherein the backrest structure is comprised of a unipartite carbon shell.

7. The backrest as claimed in claim 1, wherein the backrest structure is ergonomically shaped.

8. The backrest as claimed in claim 7, wherein the backrest structure is, in the region of the side parts, adapted to an SAE H-point manikin such that the spacing between the backrest structure and the SAE H-point manikin amounts to between 20 mm and 40 mm.

9. The backrest as claimed in claim 1, wherein the backrest structure, in a region which, in the vertical direction (z), is arranged approximately at the level of the shoulders of a seat occupant, is constricted to form a web, and in the transverse direction (y), the width of the web amounts to less than half of the maximum width of the backrest structure.

10. The backrest as claimed in claim 9, wherein the width of the web amounts to less than one third of the maximum width of the backrest structure.

11. The backrest as claimed in claim 9, wherein the web is arranged above the side parts.

12. The backrest as claimed in claim 1, wherein the backrest structure comprises, in an upper region in the vertical direction (z), a headrest support for receiving a headrest module.

13. The backrest as claimed in claim 12, wherein the headrest module comprises an adjustment mechanism which is active in the event of a crash.

14. The backrest as claimed in claim 1 further comprising at least one fitting, wherein the backrest is attached by way of the at least one fitting to a seat base structure so as to be adjustable about a backrest pivot axis, and a fitting upper part of the fitting is received in a depression of the backrest structure.

15. A vehicle seat comprising:
a backrest comprising:
a load-bearing backrest structure of a shell construction; and
a design shell which covers at least a rear side of the backrest structure, wherein an opening is provided in the backrest structure, the opening is delimited by two side parts of the backrest structure, and the width of the opening amounts to at least 50% of a maximum width of the backrest structure.

16. The vehicle seat as claimed in claim 15, wherein the opening is delimited in a downward direction by a crossmember of the backrest structure.

17. The vehicle seat as claimed in claim 16, wherein, the two side parts are respectively connected to the crossmember at outer and lower corner regions of the backrest structure and respectively extend upward therefrom and increasingly curve toward a seat center and merge to delimit the opening in an upward direction.

18. The vehicle seat as claimed in claim 17, wherein the backrest structure is of a lightweight construction and is comprised of an ergonomically shaped unipartite carbon shell.

19. The vehicle seat as claimed in claim 17, wherein
the backrest structure, in a region which, in the vertical direction (z), is arranged approximately at the level of the shoulders of a seat occupant, is constricted to form a web, and in the transverse direction (y), the width of the web amounts to less than half of the maximum width of the backrest structure;
the backrest structure comprises, in an upper region in the vertical direction above the web, a headrest support for receiving a headrest module; and
the headrest module comprises an adjustment mechanism which is active in the event of a crash.

20. The vehicle seat as claimed in claim 15, further comprising:
a seat base structure; and
at least one fitting, wherein the backrest structure is attached via the at least one fitting to the seat base structure so as to be adjustable about a backrest pivot axis, wherein a fitting upper part of the fitting is received in a depression of the backrest structure.
